(19) United States
(12) Patent Application Publication
(10) Pub. No.: US 2026/0336298 A1
(43) Pub. Date: Oct. 29, 2026

(54) LIQUID SUPPLY DEVICE AND RECORDING APPARATUS INCLUDING LIQUID SUPPLY DEVICE

(71) Applicant: KYOCERA CORPORATION, Kyoto-shi, Kyoto (JP)

(72) Inventor: Daisuke ETO, Nishi-ku, Osaka-shi, Osaka (JP)

(21) Appl. No.: 19/490,367

(22) PCT Filed: May 30, 2024
(86) PCT No.: PCT/JP2024/019960

§ 371 Date: Dec. 5, 2025

(30) Foreign Application Priority Data
Jun. 6, 2023 (JP) 2023-092876

(51) Int. Cl. B41J 2/175; B41J 2/18; G01L 15/00

(52) U.S. Cl. CPC B41J 2/175; B41J 2/18; G01L 15/00

(57) ABSTRACT

A liquid supply device includes a supply tank and a pressurizer. The supply tank stores a liquid to be supplied to a liquid ejection head. The pressurizer provides a positive pressure to the supply tank through a gas to cause an internal space of the supply tank to have a positive pressure higher than an atmospheric pressure. The pressurizer includes a supply regulator, a pressurizing tube, and a branch tube. The supply regulator lowers a pressure of a gas from a pressure source. The pressurizing tube connects the supply regulator to the supply tank to allow the gas with the pressure lowered by the supply regulator to flow to the supply tank. The branch tube branches from a point on the pressurizing tube and includes a terminal end being open to atmosphere.

### RELATED APPLICATIONS

The present application is a National Phase of International Application No. PCT/JP2024/019960 filed May 30, 2024, which claims priority to Japanese Application No. 2023-092876, filed Jun. 6, 2023.

### TECHNICAL FIELD

The present disclosure relates to a liquid supply device and a recording apparatus including the liquid supply device.

### BACKGROUND OF INVENTION

A known inkjet printer (printing apparatus) is described in Patent Literature 1 as one such type of recording apparatus described above. The inkjet printer includes an ejection head that ejects ink onto a recording medium (print medium), and a liquid supply device (ink supply device) that supplies ink to the ejection head. The liquid supply device includes a supply tank, a collection tank, a circulation pump, a supply depressurizer, and a collection depressurizer. The supply tank stores a liquid to be supplied to the ejection head. The collection tank stores a liquid collected from the ejection head. The circulation pump returns ink in the collection tank to the supply tank. The supply depressurizer includes a negative pressure pump and other components that provide a negative pressure to the supply tank. The collection depressurizer includes a negative pressure pump and other components that provide a negative pressure to the collection tank.

During printing performed by the inkjet printer described above, the supply depressurizer and the collection depressurizer are controlled to generate a predetermined pressure difference between the supply tank and the collection tank. This pressure difference causes ink to move from the supply tank to the collection tank through the ejection head. The moved ink is returned from the collection tank to the supply tank by the circulation pump.

### CITATION LIST

### Patent Literature

Patent Literature 1: Japanese Unexamined Patent Application Publication No. 2020-44823

### SUMMARY

In one aspect of the present disclosure, a liquid supply device includes a supply tank and a pressurizer. The supply tank stores a liquid to be supplied to a liquid ejection head. The pressurizer provides a positive pressure to the supply tank through a gas to cause an internal space of the supply tank to have a positive pressure higher than an atmospheric pressure. The pressurizer includes a supply regulator, a pressurizing tube, and a branch tube. The supply regulator restricts a flow of a gas from a predetermined pressure source to lower a pressure of the gas. The pressurizing tube connects the supply regulator to the supply tank to allow the gas with the pressure lowered by the supply regulator to flow to the supply tank. The branch tube branches from a point on the pressurizing tube and includes a terminal end being open to atmosphere.

In another aspect of the present disclosure, a recording apparatus includes the above liquid supply device and the liquid ejection head. The liquid supply device supplies ink being the liquid. The liquid ejection head ejects the ink supplied from the liquid supply device onto a predetermined recording medium.

### BRIEF DESCRIPTION OF THE DRAWINGS

FIG. 1 is a perspective view of an inkjet printer according to one embodiment of the present disclosure, illustrating its overall structure.

FIG. 2 is a schematic cross-sectional view taken along line II-II in FIG. 1.

FIG. 3 is an enlarged perspective view of a carriage in the inkjet printer.

FIG. 4 is a schematic system diagram of a liquid supply device mounted on the carriage, illustrating its structure.

FIG. 5 is a system diagram of a pressurizer in the liquid supply device, illustrating its mechanical and electrical structure.

FIG. 6 is a system diagram of a depressurizer in the liquid supply device, illustrating its mechanical and electrical structure.

FIG. 7 is a schematic diagram of a pressurizing tube and a branch tube in the pressurizer, illustrating their structures.

FIG. 8 is a schematic diagram of a vacuum ejector in the depressurizer, illustrating its structure.

FIG. 9 is a perspective view of the pressurizing tube and the branch tube illustrating their layouts.

### DESCRIPTION OF EMBODIMENTS

A recording apparatus according to one embodiment of the present disclosure will be described below with reference to the drawings. In one or more embodiments below, an inkjet printer including an ink head that ejects ink for image formation onto a wide and long recording medium will be described as a specific example of the recording apparatus. The inkjet printer may be used for digital textile printing to print images such as letters or patterns by inkjet printing on a recording medium, including a textile such as woven fabric or knitted fabric. In one or more embodiments of the present disclosure, the recording apparatus is also usable for printing various images on a recording medium such as a paper sheet or a resin sheet.

### Overall Structure of Inkjet Printer

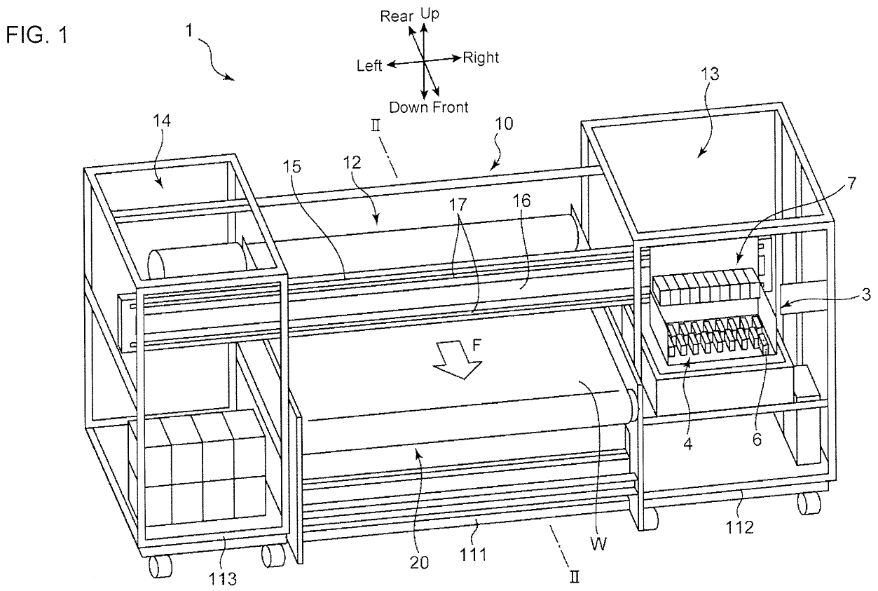

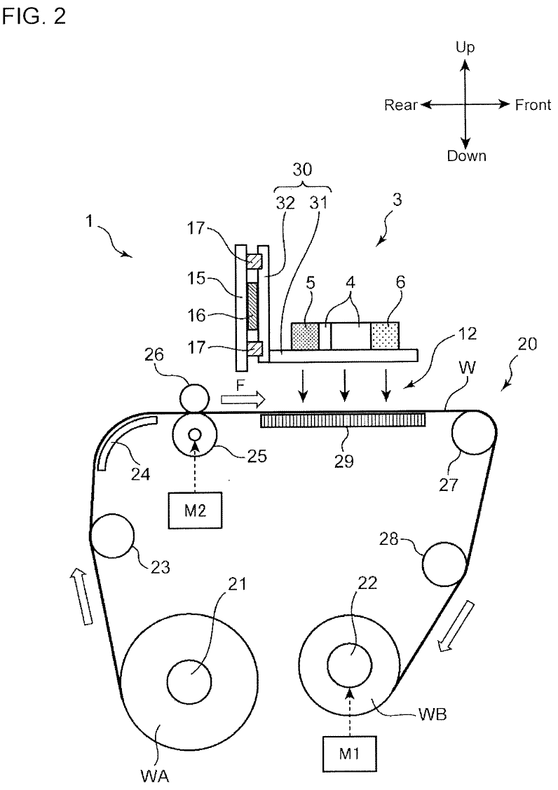

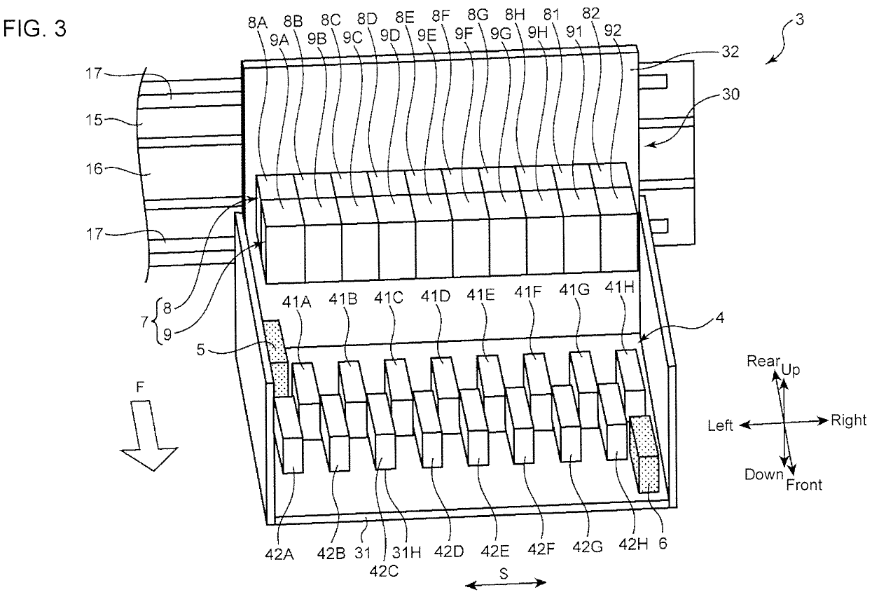

FIG. 1 is a perspective view of an inkjet printer 1 according to one embodiment of the present disclosure, illustrating its overall structure. FIG. 2 is a schematic cross-sectional view taken along line II-II in FIG. 1. The inkjet printer 1 is a printer for printing an image on a wide and long workpiece W (recording medium) by inkjet printing. An example workpiece W is several meters wide. The printer 1 includes an apparatus frame 10, and a workpiece feeder 20 and a carriage 3 assembled to the apparatus frame 10. Note that a lateral direction is a main scanning direction S (FIG. 3) in printing on the workpiece W, and a direction from rear to front is a subscanning direction (a feed direction F of the workpiece W intersecting with the main scanning direction S) in the present embodiment.

The apparatus frame 10 is a frame on which various components of the inkjet printer 1 are mounted. The workpiece feeder 20 is an assembly that intermittently feeds (transports) the workpiece W to allow the workpiece W to move in the feed direction F from rear to front in a printing area in which an inkjet printing process is performed. The carriage 3 carries ink heads 4, a pretreatment liquid head 5 (FIG. 3), a post-treatment liquid head 6, and a liquid supply device 7. The carriage 3 reciprocates in the main scanning direction S (lateral direction) intersecting with the feed direction F of the workpiece W during the inkjet printing process. Note that each of the ink heads 4 corresponds to “a liquid ejection head” in one or more embodiments of the present disclosure.

The apparatus frame 10 includes a center frame 111, a right frame 112, and a left frame 113. The center frame 111 is a frame on which various components of the inkjet printer 1 are mounted. The center frame 111 has a lateral width corresponding to the workpiece feeder 20. The right frame 112 stands on the right of the center frame 111, and the left frame 113 stands on the left of the center frame 111. A printing area 12 in which a printing process is performed on the workpiece W is defined between the right frame 112 and the left frame 113.

The right frame 112 defines a maintenance area 13. The maintenance area 13 is an area into which the carriage 3 is retracted when the printing process is not performed. In the maintenance area 13, nozzles (ejection orifices) of the ink heads 4, the pretreatment liquid head 5, and the post-treatment liquid head 6 are, for example, cleaned or purged, and each of the nozzles is capped. The left frame 113 defines a turn-back area 14 for the carriage 3. The turn-back area 14 is an area for the carriage 3 that has performed main scanning on the printing area 12 from right to left in the printing process to enter temporarily before performing main scanning in the reverse direction.

The apparatus frame 10 receives, on its upper portion, a carriage guide 15 for guiding the carriage 3 to reciprocate in the lateral direction. The carriage guide 15 as a flat plate elongated in the lateral direction is located above the workpiece feeder 20. The carriage guide 15 receives a timing belt 16 rotatable in the lateral direction (main scanning direction). The timing belt 16 is an endless belt that is driven to rotate in the left direction or the right direction.

The carriage guide 15 includes a pair of upper and lower guide rails 17 holding the carriage 3 in a manner reciprocable in the main scanning direction S. The pair of guide rails 17 extend parallel to each other in the lateral direction. The carriage 3 is engaged with the guide rails 17. The carriage 3 is fixed to the timing belt 16. The carriage 3, while being guided by the guide rails 17, moves in the left direction or the right direction along the carriage guide 15 as the timing belt 16 rotates in the left direction or the right direction.

Referring mainly to FIG. 2, the workpiece feeder 20 includes a feed roller 21 that unwinds the workpiece W before printing, and a take-up roller 22 that winds the workpiece W after printing. The feed roller 21 is located in a lower rear portion of the apparatus frame 10. The feed roller 21 is a winding shaft of a feed roll WA as a wound roll of the workpiece W before printing. The take-up roller 22 is located in a lower front portion of the apparatus frame 10. The take-up roller 22 is a winding shaft of a take-up roll WB as a wound roll of the workpiece W after the printing process. The take-up roller 22 includes a first motor M1 that rotates the take-up roller 22 about its axis to wind the workpiece W.

A path extending through the printing area 12 between the feed roller 21 and the take-up roller 22 is a feed path of the workpiece W. This feed path includes, in the order from upstream, a first tension roller 23, a workpiece guide 24, a transport roller 25 and a pinch roller 26, a turn roller 27, and a second tension roller 28. The first tension roller 23 applies a predetermined tension to the workpiece W upstream from the transport roller 25. The workpiece guide 24 redirects the workpiece W from upward to frontward and feeds the workpiece W into the printing area 12.

The transport roller 25 generates a feed force for feeding the workpiece W intermittently in the printing area 12. The transport roller 25, which is driven by a second motor M2, rotates about its axis and intermittently feeds the workpiece W frontward (predetermined feed direction F) to allow the workpiece W to pass through the printing area 12 (image formation position) facing the carriage 3. The pinch roller 26 faces the transport roller 25 from above and forms a feed nip with the transport roller 25.

The turn roller 27 changes the feed direction and redirects the workpiece W that has passed through the printing area 12 from frontward to downward, and guides the workpiece W after the printing process to the take-up roller 22. The second tension roller 28 applies a predetermined tension to the workpiece W downstream from the transport roller 25. A platen 29 is located below the feed path of the workpiece W in the printing area 12.

The carriage 3 reciprocates, while being held by the guide rails 17 in a cantilevered manner, in the main scanning direction S (the lateral direction in the present embodiment) intersecting with (perpendicular to in the present embodiment) the feed direction F. The carriage 3 includes a carriage frame 30 as well as the ink heads 4, the pretreatment liquid head 5, the post-treatment liquid head 6, and the liquid supply device 7 mounted on the carriage frame 30. The carriage frame 30 includes a head support frame 31 and a back frame 32.

The head support frame 31 is a horizontal plate holding the heads 4 to 6 described above. The back frame 32 is a vertical plate extending upward from a rear edge of the head support frame 31. As described above, the timing belt 16 is fixed to the back frame 32. The guide rails 17 are engaged with the back frame 32. In other words, the back frame 32 is an engaging portion held by the guide rails 17 in a cantilevered manner in the present embodiment. The head support frame 31 is a horizontal plate including a rear end portion held by the guide rails 17 in a cantilevered manner with the engaging portion.

Note that being held in a cantilevered manner refers to a state in which the engaging portion (back frame 32) in the carriage 3 held by the guide rails 17 as holding members is located upstream or downstream alone from the middle of the carriage 3 in the feed direction F, with no other engaging portion in an area opposite to the area including the engaging portion. The engaging portion may also be located outside an area including the ink heads 4 and the treatment liquid heads in the feed direction F. In other words, the engaging portion may be located upstream or downstream alone from the area including the ink heads 4 and the treatment liquid heads in the feed direction F.

### Details of Carriage

The carriage 3 will be described further. FIG. 3 is an enlarged perspective view of the carriage 3 illustrated in FIG. 1. In FIG. 3, the feed direction F (subscanning direction) of the workpiece W and the main scanning direction S in which the carriage 3 moves are illustrated. In the example illustrated in FIG. 3, the carriage 3 carries multiple ink heads 4 that eject ink for image formation onto the workpiece W, the pretreatment liquid head 5 and the post-treatment liquid head 6 that eject noncolor-developing treatment liquids, and the liquid supply device 7 that supplies the ink and the treatment liquids described above to the heads 4 to 6.

Each of the ink heads 4 includes many nozzles (ink ejection orifices) and an ink channel that guides ink to the nozzles. The nozzles eject ink droplets by, for example, piezoelectric ejection using piezoelectric elements or thermal ejection using heating elements. Examples of the ink include water-based pigment ink containing a water-based solvent, a pigment, and a bonding resin (binder). In the present embodiment, the multiple ink heads 4 can eject eight colors of ink. The ink heads 4 are mounted on the head support frame 31 in the carriage 3 in two arrays in the main scanning direction S. Two ink heads 4 are used for each color.

More specifically, the multiple ink heads 4 include a first upstream ink head 41A and a first downstream ink head 42A. These ink heads 4 eject yellow ink. The ink heads 4 also include a second upstream ink head 41B and a second downstream ink head 42B. These ink heads 4 eject magenta ink. In the same or a similar manner, two ink heads 4 that eject the same color of ink are arranged in a manner displaced from each other in the feed direction F and the main scanning direction S as illustrated in FIG. 3. With these two ink heads 4 being paired, a total of eight pairs of ink heads 4 (41A to 41H and 42A to 42H) eject different colors of ink. More specifically, the multiple ink heads 4 include the first upstream ink head 41A to the eighth upstream ink head 41H and the first downstream ink head 42A to the eighth downstream ink head 42H. Note that the first upstream ink head 41A to the eighth upstream ink head 41H may be hereafter simply referred to as the upstream ink heads 41 without being distinguished from one another. In the same or a similar manner, the first downstream ink heads 42A to the eighth downstream ink head 42H may be hereafter simply referred to as the downstream ink heads 42 without being distinguished from one another.

The pretreatment liquid head 5 and the post-treatment liquid head 6 are at different positions from the ink heads 4 in the feed direction F. The pretreatment liquid head 5 is upstream from the ink heads 4 in the feed direction F. In the example illustrated in FIG. 3, a single pretreatment liquid head 5 is located adjacent to the left end of an array of ink heads 4. In the same or a similar manner, the post-treatment liquid head 6 is downstream from the ink heads 4 in the feed direction F. In the example illustrated in FIG. 3, a single post-treatment liquid head 6 is located at the right end of an array of ink heads 4. In another embodiment, multiple pretreatment liquid heads 5 or multiple post-treatment liquid heads 6 may be arranged. Although the carriage 3 may carry at least one pretreatment liquid head 5 and at least one post-treatment liquid head 6, the carriage 3 may carry none of the pretreatment liquid head 5 or the post-treatment liquid head 6 in another embodiment.

Note that a series of heads including the ink heads 4, the pretreatment liquid head 5, and the post-treatment liquid head 6 aligned in the main scanning direction S is referred to as an array of heads, or simply an array. A series of heads including the ink heads 4, the pretreatment liquid head 5, and the post-treatment liquid head 6 aligned in the feed direction F is referred to as a line of heads, or simply a line.

The pretreatment liquid head 5 ejects a pretreatment liquid for a predetermined pretreatment of the workpiece W. The pretreatment liquid is ejected from the pretreatment liquid head 5 onto an area of the workpiece W on which no ink has been ejected from the ink heads 4. The pretreatment liquid is a noncolor-developing treatment liquid that develops no color on the workpiece W, and improves, for example, fixation of ink on the workpiece W or facilitates agglomeration of ink pigments. Examples of the pretreatment liquid include a treatment liquid of a solvent containing a bonding resin and a treatment liquid of a solvent containing a positively charged cationic resin.

The post-treatment liquid head 6 ejects a post-treatment liquid for a predetermined post-treatment of the workpiece W with ink applied. The post-treatment liquid is ejected from the post-treatment liquid head 6 onto an area of the workpiece W on which ink has been ejected from the ink heads 4. The post-treatment liquid is also a noncolor-developing treatment liquid that develops no color on the workpiece W. The post-treatment liquid improves the fixation and the toughness (durability against rubbing or scratching) of an ink image printed on the workpiece W by the ink heads 4. Examples of the post-treatment liquid include a silicone treatment liquid. Note that the post-treatment liquid is different from the pretreatment liquid. More specifically, the post-treatment liquid and the pretreatment liquid contain different components.

The noncolor-developing treatment liquid refers to a liquid that is not perceptible as having developed a color to the naked eye when printed on a recording medium alone. The color includes colors with zero saturation, such as black, white, and gray. Although the noncolor-developing treatment liquid is basically a transparent liquid, a liter of treatment liquid in a liquid state may appear, for example, slightly white or another color. Such a faint color is not perceptible as having developed a color to the naked eye when printed on a recording medium alone. Note that a change, such as adding gloss to the recording medium, caused by a type of treatment liquid printed alone on a recording medium is not referred to as developing a color.

In the present embodiment, the pretreatment liquid and the post-treatment liquid may be ejected across substantially the entire surface of the workpiece W, or may be selectively ejected based on an image to be printed in the same manner as or in a similar manner to the ink.

Selective ejection of the pretreatment liquid and the post-treatment liquid will now be described. As described above, the pretreatment liquid, the ink, and the post-treatment liquid are ejected in this order onto an area of the workpiece W on which colors are printed based on an image. In this case, the ink may have one color or multiple colors. For an area on which no color is printed, or in other words, an area onto which no ink is ejected, no pretreatment liquid or no post-treatment liquid is basically ejected. Note that the quality of an image to be printed or the texture of the workpiece W may be adjusted by using areas on which the pretreatment liquid and the post-treatment liquid are selectively ejected partially different from an area onto which ink is selectively ejected.

As illustrated in FIG. 3, the head support frame 31 includes openings 31H at positions of the heads. The head support frame 31 receives the ink heads 4, the pretreatment liquid head 5, and the post-treatment liquid head 6 fitted into the respective openings 31H. The nozzles on the lower end face of each of the heads 4, 5, and 6 are exposed through the corresponding opening 31H.

The liquid supply device 7 includes supply subtanks 8 and collection subtanks 9. The supply subtanks 8 store liquids (ink or a treatment liquid) to be supplied to the heads 4, 5, and 6. The collection subtanks 9 store liquids collected from the heads 4, 5, and 6. The carriage 3 supports the subtanks 8 and 9 with the collection subtanks 9 frontward from the supply subtanks 8. Note that each of the supply subtanks 8 corresponds to “a supply tank” in one or more embodiments of the present disclosure, and each of the collection subtanks 9 corresponds to “a collection tank” in one or more embodiments of the present disclosure.

The supply subtanks 8 include a first supply subtank 8A to an eighth supply subtank 8H, a pretreatment supply subtank 81, and a post-treatment supply subtank 82 arranged in the main scanning direction S. The supply subtanks 8A to 8H, 81, and 82 correspond to the respective heads 4, 5, and 6. More specifically, each of the first supply subtank 8A to the eighth supply subtank 8H stores ink to be supplied to the corresponding ink head of the multiple ink heads 4 (41A to 41H and 42A to 42H). The pretreatment supply subtank 81 stores the pretreatment liquid to be supplied to the pretreatment liquid head 5. The post-treatment supply subtank 82 stores the post-treatment liquid to be supplied to the post-treatment liquid head 6. Each of the supply subtanks 8A to 8H, 81, and 82 receives the corresponding one of the ink and the treatment liquids from a main tank 70 (described later).

The collection subtanks 9 include a first collection subtank 9A to an eighth collection subtank 9H, a pretreatment collection subtank 91, and a post-treatment collection subtank 92 arranged in the main scanning direction S. The collection subtanks 9A to 9H, 91, and 92 correspond to the respective heads 4, 5, and 6. More specifically, each of the first collection subtank 9A to the eighth collection subtank 9H stores ink collected from the corresponding ink head of the multiple ink heads 4 (41A to 41H and 42A to 42H). The pretreatment collection subtank 91 stores the pretreatment liquid collected from the pretreatment liquid head 5. The post-treatment collection subtank 92 stores the post-treatment liquid collected from the post-treatment liquid head 6.

The multiple subtanks described above, or the supply subtanks 8A to 8H, 81, and 82 and the collection subtanks 9A to 9H, 91, and 92, are supported above the heads 4, 5, and 6 by the carriage 3 with a holding frame (not illustrated) between the multiple subtanks and the carriage 3. Each of the subtanks is connected to the corresponding head 4, 5, or 6 with a tube (not illustrated in FIG. 3).

The first supply subtank 8A and the first collection subtank 9A located leftmost in the carriage 3 store yellow ink containing pigments. The first supply subtank 8A supplies yellow ink to the first upstream ink head 41A and the first downstream ink head 42A. The first collection subtank 9A stores yellow ink collected from the first upstream ink head 41A and the first downstream ink head 42A. Note that part of yellow ink is ejected from the first upstream ink head 41A and the first downstream ink head 42A onto the workpiece W as described above.

In the same or a similar manner, the second supply subtank 8B supplies magenta ink to the second upstream ink head 41B and the second downstream ink head 42B. The second collection subtank 9B stores magenta ink collected from the second upstream ink head 41B and the second downstream ink head 42B.

The other ink subtanks, or specifically the third supply subtank 8C to the eighth supply subtank 8H and the third collection subtank 9C to the eighth collection subtank 9H, also have the same structure and function as or similar structures and functions to the ink subtanks described above.

The pretreatment supply subtank 81 supplies the pretreatment liquid to the pretreatment liquid head 5, and the pretreatment collection subtank 91 collects the pretreatment liquid from the pretreatment liquid head 5. The post-treatment supply subtank 82 supplies the post-treatment liquid to the post-treatment liquid head 6, and the post-treatment collection subtank 92 collects the post-treatment liquid from the post-treatment liquid head 6.

In the present embodiment, as described above, the inkjet printer 1 is an all-in-one printer including three types of heads, or the ink heads 4, the pretreatment liquid head 5, and the post-treatment liquid head 6, mounted on the single carriage 3. The inkjet printer 1 can integrally perform the pretreatment liquid ejection and the post-treatment liquid ejection in a textile printing process for performing inkjet printing on a textile in, for example, digital textile printing. This can simplify the textile printing process and reduce the size of a textile printing apparatus.

Note that the inkjet printer 1 according to the present embodiment performs the printing process on the workpiece W by serial printing. More specifically, for a wide workpiece W, the workpiece W cannot undergo printing while being fed continuously. With serial printing, the carriage 3 carrying the ink heads 4 for the respective colors repeatedly reciprocates in the main scanning direction S while the workpiece W is being intermittently fed in the feed direction F.

More specifically, the carriage 3 moving in an outgoing direction, which is one direction along the main scanning direction S, prints a strip image. During the main scanning in the outgoing direction, the feed of the workpiece W is stopped. The workpiece W on which the strip image has been printed is then fed forward in the feed direction F by a predetermined pitch. During the feed, the carriage 3 stays in the turn-back area 14 at the left end. After the workpiece W is fed forward, the carriage 3 turns back in a return direction opposite to the outgoing direction, as the timing belt 16 rotates in the reverse direction. During this time, the workpiece W is stationary. The carriage 3 then moves in the return direction and prints a subsequent strip image upstream from the strip image that has been printed as described above. The same or similar movement is repeated subsequently.

### Circulation System for Ink and Treatment Liquids

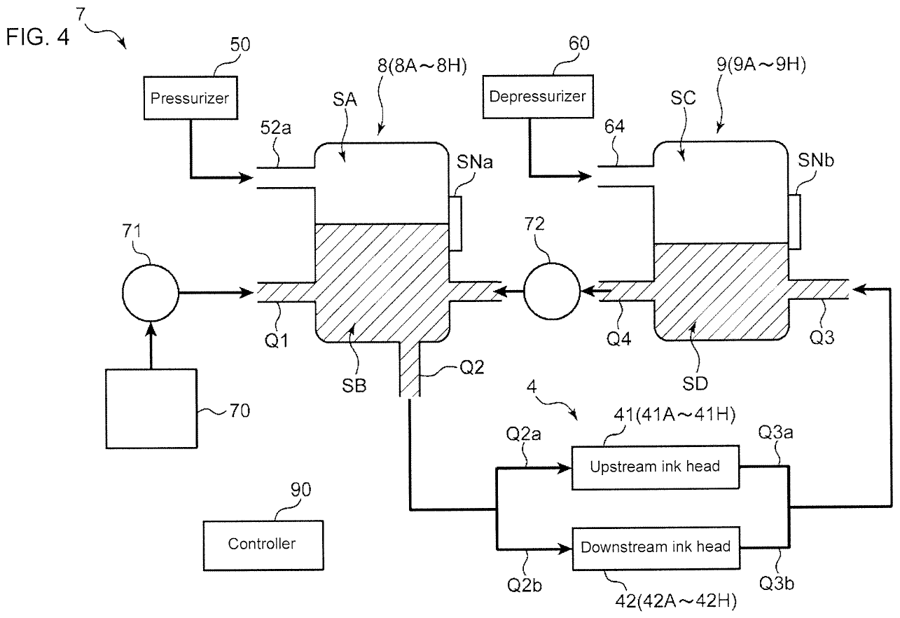

The flow of the ink and the treatment liquids in the inkjet printer 1 according to the present embodiment will now be described. FIG. 4 is a schematic system diagram of the liquid supply device 7, illustrating its structure. In FIG. 4, the lines connecting the components indicate tubes for carrying a gas or a liquid. Note that the same or a similar structure as in FIG. 4 illustrating the flow of ink supplied to the ink heads 4 (41A to 41H and 42A to 42H) using the first supply subtank 8A to the eighth supply subtank 8H and the first collection subtank 9A to the eighth collection subtank 9H is used for the pretreatment liquid supplied to the pretreatment liquid head 5 and the post-treatment liquid supplied to the post-treatment liquid head 6. More specifically, when the pretreatment liquid is supplied to the pretreatment liquid head 5 using the pretreatment supply subtank 81 and the pretreatment collection subtank 91 and the post-treatment liquid is supplied to the post-treatment liquid head 6 using the post-treatment supply subtank 82 and the post-treatment collection subtank 92, the same or a similar structure as in FIG. 4 is used for supplying the respective treatment liquids.

As illustrated in FIG. 4, the liquid supply device 7 includes the main tank 70, a main supply pump 71, and a circulation pump 72 in addition to the various subtanks described above. These components are prepared for each color of ink. More specifically, a set of the main tank 70, the main supply pump 71, and the circulation pump 72 is prepared for a combination of the first supply subtank 8A and the first collection subtank 9A that store yellow ink. In the same or a similar manner, a set of the main tank 70, the main supply pump 71, and the circulation pump 72 is also prepared for each of the combinations of the supply subtank 8B to the supply subtank 8H and the collection subtank 9B to the collection subtank 9H that store the respective colors of ink. Note that the first supply subtank 8A to the eighth supply subtank 8H may be hereafter simply referred to as the supply subtanks 8 without being distinguished from one another. In the same or a similar manner, the first collection subtank 9A to the eighth collection subtank 9H may be simply referred to as the collection subtanks 9 without being distinguished from one another.

The main tank 70 stores ink and is mounted on the apparatus frame 10 (FIG. 1) outside the carriage 3.

The main supply pump 71 operates to supply ink in the main tank 70 to the corresponding supply subtank 8. The main supply pump 71 is connected to the corresponding supply subtank 8 through an ink refill channel Q1.

The circulation pump 72 operates to return ink in the corresponding collection subtank 9 to the corresponding supply subtank 8. The circulation pump 72 is located on an ink return channel Q4 connecting the supply subtank 8 and the collection subtank 9.

The supply subtank 8 and the collection subtank 9 are connected to each other through an ink supply channel Q2 extending through the ink heads 4 (41 and 42) and an ink collection channel Q3.

The ink supply channel Q2 includes a downstream portion branching into a first supply channel Q2a connecting to the corresponding upstream ink head 41 and a second supply channel Q2b connecting to the corresponding downstream ink head 42. In the same or a similar manner, the ink collection channel Q3 includes an upstream portion branching into a second collection channel Q3a connecting to the upstream ink head 41 and a second supply channel Q3b connecting to the downstream ink head 42.

The liquid supply device 7 further includes a pressurizer 50, a depressurizer 60, and a controller 90. These components are prepared for each of the colors of ink and the treatment liquids (the pretreatment liquid and the post-treatment liquid).

The pressurizer 50 provides a positive pressure to the supply subtank 8 through air to cause the internal space (a gas area SA described later) of the supply subtank 8 to have a positive pressure higher than the atmospheric pressure. The structure of the pressurizer 50 will be described in detail later.

The depressurizer 60 provides a negative pressure to the collection subtank 9 through air to cause the internal space of the collection subtank 9 (a gas area SC described later) to have a negative pressure lower than the atmospheric pressure. The structure of the depressurizer 60 will be described in detail later.

The controller 90 centrally controls the operation of the liquid supply device 7. The controller 90 includes a processor and various memories. For example, the controller 90 controls the pressurizer 50 and the depressurizer 60 to maintain the internal space of the supply subtank 8 at a constant positive pressure and the internal space of the collection subtank 9 at a constant negative pressure. This causes ink to be supplied from the respective supply subtanks 8 to the ink heads 4 (41 and 42), and ink to be collected from the ink heads 4 into the respective collection subtanks 9. The collected ink is returned to the supply subtanks 8 as appropriate. More specifically, the ink circulates between the supply subtanks 8 and the collection subtanks 9 through the ink heads 4.

Each of the supply subtanks 8 with, for example, a box-like structure defines the gas area SA and an ink area SB when ink is stored inside the supply subtank 8. The gas area SA is an area (space) occupied with air above the level of ink in the supply subtank 8. The ink area SB is an area occupied with the ink. The gas area SA is continuous with the pressurizer 50 and is held at a predetermined positive pressure under a pressure provided by the pressurizer 50 through air. The ink area SB is continuous with the ink refill channel Q1, the ink supply channel Q2, and the ink return channel Q4 described above.

In the same or a similar manner, each of the collection subtanks 9 with a box-like structure defines the gas area SC and an ink area SD when ink is stored inside the collection subtank 9. The gas area SC is an area (space) occupied with air above the level of ink in the collection subtank 9. The ink area SD is an area occupied with the ink. The gas area SC is continuous with the depressurizer 60 and is held at a predetermined negative pressure under a pressure provided by the depressurizer 60 through air. The ink area SD is continuous with the ink collection channel Q3 and the ink return channel Q4 described above.

A capacitive sensor SNa is attached to the supply subtank 8. The capacitive sensor SNa can detect the level of ink (the amount of ink) stored in the supply subtank 8. In the same or a similar manner, a capacitive sensor SNb is attached to the collection subtank 9. The capacitive sensor SNb can detect the level of ink (the amount of ink) in the collection subtank 9.

With reference to FIG. 4, the circulation of yellow ink will now be described. The main supply pump 71 operates to supply yellow ink from the main tank 70 storing the yellow ink to the first supply subtank 8A through the ink refill channel Q1. The yellow ink in the first supply subtank 8A is supplied to the first upstream ink head 41A and the first downstream ink head 42A through the ink supply channel Q2.

After the first upstream ink head 41A and the first downstream ink head 42A eject part of the yellow ink onto the workpiece W, the remaining yellow ink is collected into the first collection subtank 9A through the ink collection channel Q3. The collected yellow ink is then returned to the first supply subtank 8A through the ink return channel Q4.

When the controller 90 determines that, in response to an output signal from the capacitive sensor SNa, the ink in the first supply subtank 8A is reduced, the circulation pump 72 operates in response to a command signal input from the controller 90. This returns part of the yellow ink in the first collection subtank 9A to the first supply subtank 8A through the ink return channel Q4. Note that the circulation pump 72 operates independently of whether the inkjet printer 1 is performing or stopping printing.

Additionally, when the controller 90 determines, based on the detection results from the capacitive sensors SNa and SNb, that the amounts of yellow ink in both the first supply subtank 8A and the first collection subtank 9A have reduced below a predetermined threshold, the controller 90 operates the main supply pump 71 to refill the first supply subtank 8A with yellow ink from the main tank 70 through the ink refill channel Q1.

The circulation of yellow ink is described above as a typical example. The circulation of each of the other colors of ink is also performed in the same or a similar manner. The circulation of the pretreatment liquid or the post-treatment liquid is also performed in the same or a similar manner. More specifically, the pressurizer 50, the depressurizer 60, the main tank 70, the main supply pump 71, and the circulation pump 72 described above are also used to circulate the pretreatment liquid or the post-treatment liquid in the same or a similar manner. This structure allows the flow of the pretreatment liquid to circulate between the pretreatment supply subtank 81 and the pretreatment collection subtank 91 through the pretreatment liquid head 5. This structure also allows the flow of the post-treatment liquid to circulate between the post-treatment supply subtank 82 and the post-treatment collection subtank 92 through the post-treatment liquid head 6.

### Detailed Structures of Pressurizer and Depressurizer

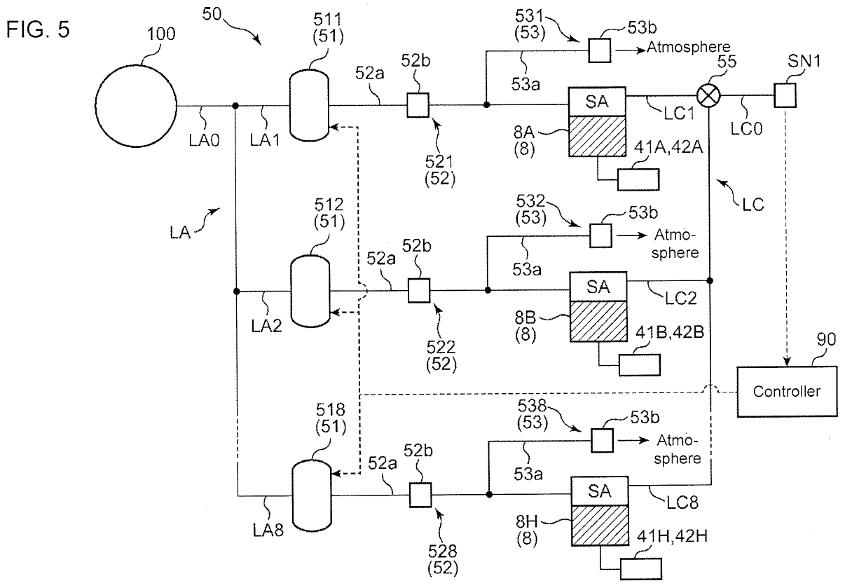

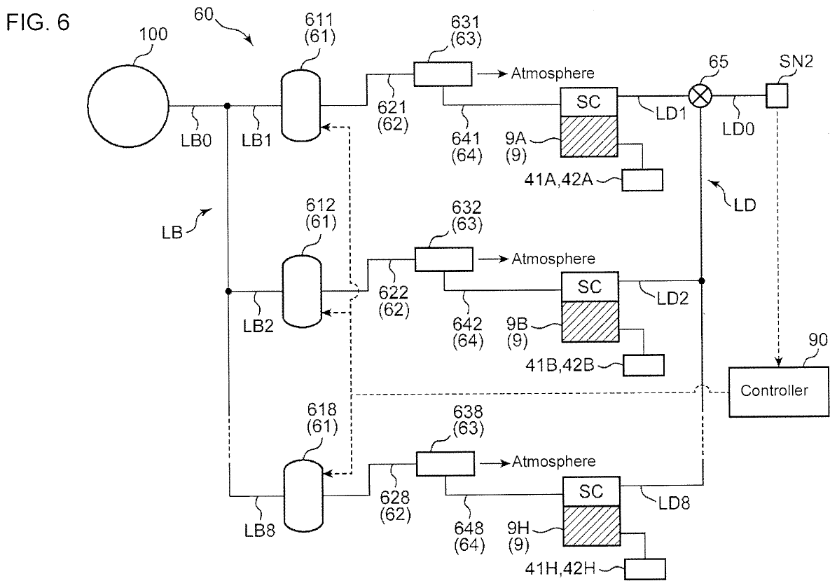

The structures of the pressurizer 50 and the depressurizer 60 will now be described in detail. FIG. 5 is a system diagram of the pressurizer 50, illustrating its mechanical and electrical structure. FIG. 6 is a schematic system diagram of the depressurizer 60, illustrating its mechanical and electrical structure. Although FIG. 5 illustrates the structure for pressurizing the first supply subtank 8A to the eighth supply subtank 8H in the pressurizer 50, the same or a similar structure is used for pressurizing the other subtanks (the pretreatment supply subtank 81 and the post-treatment supply subtank 82). Although FIG. 6 illustrates the structure for depressurizing the first collection subtank 9A to the eighth collection subtank 9H in the depressurizer 60, the same or a similar structure is used for depressurizing the other subtanks (the pretreatment collection subtank 91 and the post-treatment collection subtank 92).

As illustrated in FIG. 5, the pressurizer 50 provides a predetermined positive pressure to the supply subtank 8 using air (gas) from a pressure source 100. The pressure source 100 may be any type of pressure source that functions as the source of compressed air. In the present embodiment, an air compressor external to the inkjet printer 1 is used as the pressure source 100. More specifically, the pressure source 100 is a source of compressed air used to operate various pneumatic devices at a plant facility at which the inkjet printer 1 is installed.

The pressurizer 50 includes a supply regulator 51, a pressurizing tube 52, and a branch tube 53.

The components in the pressurizer 50 described above are included in each of the supply subtanks 8. More specifically, the pressurizer 50 includes a first supply regulator 511 to an eighth supply regulator 518, a first pressurizing tube 521 to an eighth pressurizing tube 528, and a first branch tube 531 to an eighth branch tube 538, respectively corresponding to the first supply subtank 8A to the eighth supply subtank 8H. Note that FIG. 5 illustrates the first supply subtank 8A, the second supply subtank 8B, and the eighth supply subtank 8H alone and does not illustrate the other supply subtanks (8C to 8G). FIG. 5 also illustrates the corresponding first supply regulator 511, second supply regulator 512, and eighth supply regulator 518 alone, and does not illustrate the other supply regulators. The pressurizing tubes 52 (521 to 528) and the branch tubes 53 (531 to 538) are also illustrated in the same or a similar manner.

The supply regulator 51 restricts a flow of air from the pressure source 100 to lower the pressure of the air. The supply regulator 51 is, for example, an electropneumatic regulator. The air pressure lowered by the supply regulator 51, or more specifically, the outlet pressure of the supply regulator 51, can be changed in response to a command from the controller 90.

The supply regulator 51 is connected to the pressure source 100 through a supply pressurizing channel LA. The supply pressurizing channel LA includes a common channel LA0 extending from the pressure source 100, and a first branch channel LA1 to an eighth branch channel LA8 each branching from the common channel LA0 to the corresponding regulator of the first supply regulators 511 to the eighth supply regulator 518. The common channel LA0 may include a primary regulator. Note that FIG. 5 illustrates the first branch channel LA1, the second branch channel LA2, and the eighth branch channel LA8 alone, respectively corresponding to the first supply regulator 511, the second supply regulator 512, and the eighth supply regulator 518, and does not illustrate the other branch channels.

The pressurizing tube 52 feeds air with a pressure lowered by the supply regulator 51 to the supply subtank 8. The pressurizing tube 52 includes a first basal portion 52a and a first metering valve 52b located on the first basal portion 52a. The first basal portion 52a connects the regulator 51 to the gas area SA in the supply subtank 8. The first metering valve 52b narrows the flow channel in the first basal portion 52a to regulate the flow rate of air flowing through the first basal portion 52a. The first metering valve 52b is a resistive component (resistor) also referred to as a speed controller. The first metering valve 52b has a higher fluidic resistance than the first basal portion 52a. The first metering valve 52b corresponds to “a first resistor” in one or more embodiments of the present disclosure.

The branch tube 53 branches from a point on the pressurizing tube 52. The branch tube 53 includes a second basal portion 53a and a second metering valve 53b at a terminal end of the second basal portion 53a. The second basal portion 53a is a tubular member branching and extending from the first basal portion 52a in the pressurizing tube 52 at a position downstream from the first metering valve 52b. The branch tube 53 has a terminal end, or the outlet of the second metering valve 53b in this example, that is open to the atmosphere. The second metering valve 53b can regulate the flow rate of air in the same manner as or in a similar manner to the first metering valve 52b in the pressurizing tube 52. The second metering valve 53b functions as a resistive component (resistor) having a higher fluidic resistance than the second basal portion 53a. The second metering valve 53b corresponds to “a second resistor” in one or more embodiments of the present disclosure. Note that the branch tube 53 may include a tube (extension tube) extending further downstream from the second metering valve 53b. When located on this extension tube, the opening to the atmosphere may serve as the terminal end of the branch tube 53.

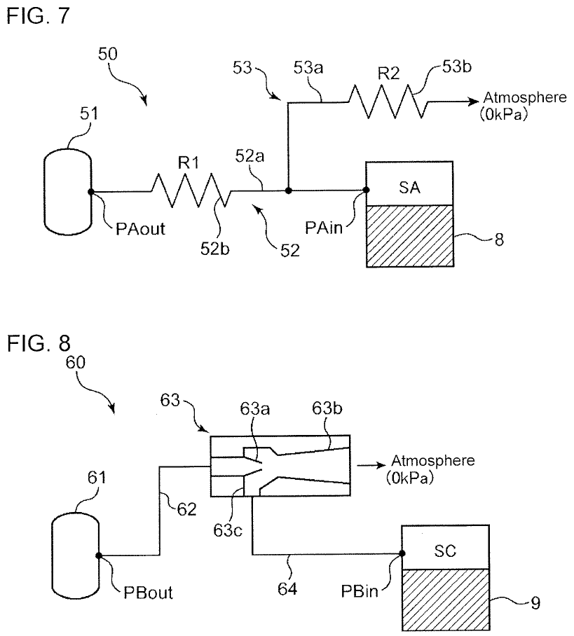

FIG. 7 is a schematic diagram of the pressurizing tube 52 and the branch tube 53, illustrating their structures. Note that FIG. 7 illustrates the first metering valve 52b in the pressurizing tube 52 and the second metering valve 53b in the branch tube 53 each represented by elements that simulate resistors in an electrical circuit for ease of explanation. As illustrated in the figure, a fluidic resistance of the first metering valve 52b is referred to as R1, and a fluidic resistance of the second metering valve 53b is referred to as R2. The outlet pressure of the supply regulator 51 is referred to as PAout, and the outlet pressure of the pressurizing tube 52, or in other words, the inlet pressure of the supply subtank 8, is referred to as PAin. Note that the fluidic resistance R1 of the first metering valve 52b is hereafter shortly referred to as the first resistance R1, and the fluidic resistance R2 of the second metering valve 53b as the second resistance R2 as appropriate. The outlet pressure PAout of the supply regulator 51 is shortly referred to as the supply regulator pressure PAout, and the inlet pressure PAin of the supply subtank 8 as the supply subtank pressure PAin.

The supply regulator pressure PAout is regulated to a substantially constant value through PID control performed by the controller 90. Air from the supply regulator 51 is depressurized while passing through the pressurizing tube 52 and introduced into the supply subtank 8. In other words, the supply subtank pressure PAin decreases in a predetermined proportion to the supply regulator pressure PAout. This rate of decrease is determined based on the first resistance R1 and the second resistance R2.

In the present embodiment, the first resistance R1 and the second resistance R2 are each predetermined to cause the supply subtank pressure PAin to be an intended value. More specifically, a resistance ratio is a value of the second resistance R2 divided by the total (R1+R2) of the first resistance R1 and the second resistance R2. The supply subtank pressure PAin is regulated to an intended value using this resistance ratio (=R2/(R1+R2)). More specifically, the resistance ratio is set to be 1/50 to 1/5 inclusive. In other words, the first metering valve 52b and the second metering valves 53b are set to each have an opening degree to cause a value of the fluidic resistance R2 of the second metering valve 53b divided by the total (R1+R2) of the fluidic resistances of the first metering valve 52b and the second metering valve 53b to be 1/50 to 1/5 in the present embodiment.

The fluidic resistance of the entire pressurizing tube 52 is substantially controlled by the fluidic resistance of the first metering valve 52b (first resistance R1). The fluidic resistance of the entire branch tube 53 is substantially controlled by the fluidic resistance of the second metering valve 53b (second resistance R2). The resistance ratio (=R 2/(R1+R2)) described above is thus equivalent to the resistance ratio between the pressurizing tube 52 and the branch tube 53. The terminal end of the branch tube 53 is open to the atmosphere and has a pressure equal to the atmospheric pressure (0 kPa). In such a structure, the ratio of the supply subtank pressure PAin to the supply regulator pressure PAout (=PAin/PAout) can be substantially the same as the above resistance ratio (=R2/(R1+R2)). In the present embodiment, the supply subtank pressure PAin is thus 1/50 to 1/5 of the supply regulator pressure PAout.

In one example, the supply regulator pressure PAout is set to +45 kPa (gauge pressure). The supply subtank pressure PAin, or in other words, the pressure of the gas area SA in the supply subtank 8, is set to +1.5 kPa (gauge pressure). This pressure can be achieved by setting the resistance ratio (=R2/(R1+R2)) described above to 1/30.

As illustrated in FIG. 5, the supply subtank 8 is connected to a first pressure sensor SN1 through a first extraction channel LC. The first extraction channel LC includes a first branch channel LC1 to an eighth branch channel LC8 extending from the respective gas areas SA in the first supply subtank 8A to the eighth supply subtank 8H, and a common channel LC0 connecting a joint of the branch channels LC1 to LC8 to a first pressure sensor SN1. A switch valve 55 is located at the joint of the branch channels LC1 to LC8. Note that FIG. 5 illustrates the first branch channel LC1, the second branch channel LC2, and the eighth branch channel LC8 alone, respectively corresponding to the first supply subtank 8A, the second supply subtank 8B, and the eighth supply subtank 8H, and does not illustrate the other branch channels.

The switch valve 55 causes the first branch channel LC1 to the eighth branch channel LC8 to be selectively continuous with the common channel LC0. For example, when the switch valve 55 operates to cause the first branch channel LC1 to be continuous with the common channel LC0, the other branch channels (LC2 to LC8) are disconnected from the common channel LC0. In this state, the first supply subtank 8A and the first pressure sensor SN1 are continuous with each other through the first branch channel LC1 and the common channel LC0. In this manner, the switch valve 55 causes the respective gas areas SA of the first supply subtank 8A to the eighth supply subtank 8H to be selectively continuous with the first pressure sensor SN1. This selective connection allows the first pressure sensor SN1 to detect the pressure of the gas area SA (supply subtank pressure PAin) in an intended tank selected from the first supply subtank 8A to the eighth supply subtank 8H.

As described above, the controller 90 regulates the outlet pressure of the supply regulator 51, or more specifically, the supply regulator pressure PAout, based on the pressure of the gas area SA in the respective supply subtanks 8 (8A to 8H) detected by the first pressure sensor SN1. More specifically, the controller 90 regulates the supply regulator pressure PAout to cause the pressure in the supply subtank 8 (gas area SA) to match a predetermined target value through PID control (feedback control) performed by the supply regulator 51 based on the output from the first pressure sensor SN1. In one example with the target value being +1.5 kPa, the controller 90 regulates the supply regular pressure PAout to maintain the pressure in the supply subtank 8 at about +1.5 kPa.

Although pressurizing of the supply subtanks 8 is described above, pressurizing of the pretreatment supply subtank 81 and the post-treatment supply subtank 82 is also performed in the same or a similar manner. More specifically, the supply regulator 51, the pressurizing tube 52, and the branch tube 53 described above are also used to provide a positive pressure to the pretreatment supply subtank 81 and the post-treatment supply subtank 82 in the same or a similar manner.

As illustrated in FIG. 6, the depressurizer 60 provides a predetermined negative pressure to the collection subtank 9 using air (gas) from the pressure source 100. The pressure source 100 used for the pressurizer 50 described above is also used for the depressurizer 60.

The depressurizer 60 includes a collection regulator 61, a discharge tube 62, a vacuum ejector 63, and a connection tube 64.

The components in the depressurizer 60 described above are included in each of the collection subtanks 9. More specifically, the depressurizer 60 includes a first collection regulator 611 to an eighth collection regulator 618, a first discharge tube 621 to an eighth discharge tube 628, a first vacuum ejector 631 to an eighth vacuum ejector 638, and a first connection tube 641 to an eighth connection tube 648, respectively corresponding to the first collection subtank 9A to the eighth collection subtank 9H. Note that FIG. 6 illustrates the first collection subtank 9A, the second collection subtank 9B, and the eighth collection subtank 9H alone, and does not illustrate the other collection subtanks (9C to 9G). FIG. 6 also illustrates the corresponding first collection regulator 611, second collection regulator 612, and eighth collection regulator 618 alone, and does not illustrate the other collection regulators. The discharge tube 62 (621 to 628), the vacuum ejector 63 (631 to 638), and the connection tube 64 (641 to 648) are also illustrated in the same or a similar manner.

The collection regulator 61 is a regulator that is the same as or similar to the supply regulator 51 described above, and is, for example, an electropneumatic regulator. The air pressure lowered by the collection regulator 61, or more specifically, the outlet pressure of the collection regulator 61, can be changed in response to a command from the controller 90.

The collection regulator 61 is connected to the pressure source 100 through a collection depressurizing channel LB. The collection depressurizing channel LB includes a common channel LB0 extending from the pressure source 100, and a first branch channel LB1 to an eighth branch channel LB8 each branching from the common channel LB0 to the corresponding regulator of the first collection regulator 611 to the eighth collection regulator 618. The common channel LB0 may include a primary regulator. Note that FIG. 6 illustrates the first branch channel LB1, the second branch channel LB2, and the eighth branch channel LB8 alone, respectively corresponding to the first collection regulator 611, the second collection regulator 612, and the eighth collection regulator 618, and does not illustrate the other branch channels.

The discharge tube 62 extends from the collection regulator 61 with its terminal end connected to the vacuum ejector 63.

FIG. 8 is a schematic diagram of the vacuum ejector 63, illustrating its structure. As illustrated in the figure, the vacuum ejector 63 includes a nozzle 63a, a diffuser 63b, and a negative pressure port 63c. The nozzle 63a is a flow channel with the cross-sectional area narrower toward downstream. The nozzle 63a is connected to the terminal end of the discharge tube 62. The diffuser 63b is a passage located coaxially with and downstream from the nozzle 63a. The diffuser 63b includes an upstream portion including an outlet of the nozzle 63a and a downstream portion having a cross-sectional area larger toward downstream. The outlet of the diffuser 63b is open to the atmosphere. The negative pressure port 63c is continuous with the upstream portion of the diffuser 63b. The negative pressure port 63c is continuous with the upstream portion of the diffuser 63b in a direction orthogonal to an axial direction of the nozzle 63a and the diffuser 63b.

Air flowing into the nozzle 63a through the discharge tube 62 increases its flow velocity while passing through the nozzle 63a, and is ejected through the outlet of the nozzle 63a at a particularly high speed. The air ejected through the nozzle 63a decreases its flow velocity in the downstream portion of the diffuser 63b, and is then discharged outside. In this state, a high negative pressure is generated around the outlet of the nozzle 63a, which is an ejection port of the air. This generates a negative pressure at the negative pressure port 63c connected to the upstream portion of the diffuser 63b.

The connection tube 64 connects the negative pressure port 63c in the vacuum ejector 63 to the gas area SC in the corresponding collection subtank 9. The connection tube 64 provides the negative pressure from the vacuum ejector 63 to the collection subtank 9.

The outlet pressure of the collection regulator 61 is referred to as PBout, and the outlet pressure of the connection tube 64, or in other words, the inlet pressure of the collection subtank 9, is referred to as PBin. Note that the outlet pressure PBout of the collection regulator 61 is hereafter shortly referred to as the collection regulator pressure PBout, and the inlet pressure PBin of the collection subtank 9 as the collection subtank pressure PBin as appropriate. The collection regulator pressure PBout is regulated to a substantially constant value sufficiently higher than the atmospheric pressure through PID control performed by the controller 90. For example, the collection regulator pressure PBout is set to a value higher than the supply regulator pressure PAout (+45 kPa in one example) described above.

The air with the pressure PBout described above flows into the nozzle 63a in the vacuum ejector 63 through the discharge tube 62, and is ejected through the outlet of the nozzle 63a at a high speed. This generates a negative pressure at the negative pressure port 63c. The negative pressure is transmitted to the collection subtank 9 through the connection tube 64, generating a negative pressure as the collection subtank pressure PBin.

The absolute value of the collection subtank pressure PBin is smaller than the collection regulator pressure PBout. In one example, the collection regulator pressure PBout is set to +160 kPa (gauge pressure). In this case, the collection subtank pressure PBin, or in other words, the pressure in the gas area SC in the collection subtank 9, is a negative pressure of, for example, about −16 kPa.

The ratio of a change in the collection subtank pressure PBin to a change in the collection regulator pressure PBout is referred to as a collection pressure change ratio ΔPb. The absolute value of the collection pressure change ratio ΔPb is sufficiently smaller than 1. Although the collection pressure change ratio ΔPb varies slightly based on the value of the collection regulator pressure PBout, the collection pressure change ratio ΔPb is about −0.1, for example, in the range of actual use with the pressure PBout being about +160 kPa. This indicates that the collection subtank pressure PBin changes by about −0.1 kPa when the collection regulator pressure PBout changes by +1 kPa.

In the present embodiment, as described above, the collection pressure change ratio ΔPb is smaller than 1. This allows regulation of the pressure in the collection subtank 9 (collection subtank pressure PBin) in smaller increments than the increments for regulation of the pressure performed by the collection regulator 61. For example, a typical electropneumatic regulator may not regulate the pressure in increments of smaller than 1 kPa. In the present embodiment with the collection pressure change ratio ΔPb being smaller than 1, the pressure in the collection subtank 9 can be regulated in increments of smaller than 1 kPa.

To obtain advantages in the supply structure (FIG. 7) as well as in the collection structure described above in the present embodiment, a supply pressure change ratio ΔPa, or more specifically, the ratio of a change in the supply subtank pressure PAin to a change in the supply regulator pressure PAout, is also set to a value smaller than 1 by a significant difference for the collection structure. More specifically, the supply pressure change ratio ΔPa and the collection pressure change ratio ΔPb are set to be a value on the same order in the present embodiment. In other words, the supply pressure change ratio ΔPa and the collection pressure change ratio ΔPb are set to satisfy the relationship written in Formula 1 below.

−0.1×ΔPb<ΔPa<−10×ΔPb (1)

As illustrated in FIG. 6, the collection subtank 9 is connected to a second pressure sensor SN2 through a second extraction channel LD. The second extraction channel LD includes a first branch channel LD1 to an eighth branch channel LD8 extending from the respective gas areas SC in the first collection subtank 9A to eighth collection subtank 9H, and a common channel LD0 connecting a joint of the branch channels LD1 to LD8 to the second pressure sensor SN2. A switch valve 65 is located at the joint of the branch channels LD1 to LD8. Note that FIG. 6 illustrates the first branch channel LD1, the second branch channel LD2, and the eighth branch channel LD8 alone, respectively corresponding to the first collection subtank 9A, the second collection subtank 9B, and the eighth collection subtank 9H, and does not illustrate the other branch channels.

The switch valve 65 is a valve that is the same as or similar to the switch valve 55 in the supply structure described above. The switch valve 65 causes the first branch channel LD1 to the eighth branch channel LD8 to be selectively continuous with the common channel LD0. The selective connection through the switch valve 65 allows the second pressure sensor SN2 to detect the pressure (collection subtank pressure PBin) of the gas area SC in an intended tank selected from the first collection subtank 9A to the eighth collection subtank 9H.

As described above, the controller 90 regulates the outlet pressure of the collection regulator 61, or more specifically, the collection regulator pressure PBout, based on the pressure of the gas area SC in the respective collection subtanks 9 (9A to 9H) detected by the second pressure sensor SN2. More specifically, the controller 90 regulates the collection regulator pressure PBout to cause the pressure in the collection subtank 9 (gas area SC) to match a predetermined target value through PID control (feedback control) performed by the collection regulator 61 based on the output from the second pressure sensor SN2. In one example with the above target value being −16 kPa, the controller 90 regulates the collection regulator pressure PBout to maintain the pressure in the collection subtank 9 at about −16 kPa.

Although depressurizing of the collection subtank 9 is described above, depressurizing of the pretreatment collection subtank 91 and the post-treatment collection subtank 92 is also performed in the same or a similar manner. More specifically, the collection regulator 61, the discharge tube 62, the vacuum ejector 63, and the connection tube 64 described above are also used to provide a negative pressure to the pretreatment collection subtank 91 and the post-treatment collection subtank 92 in the same or a similar manner. Positional Relationship between Opening to Atmosphere and Supply Regulator

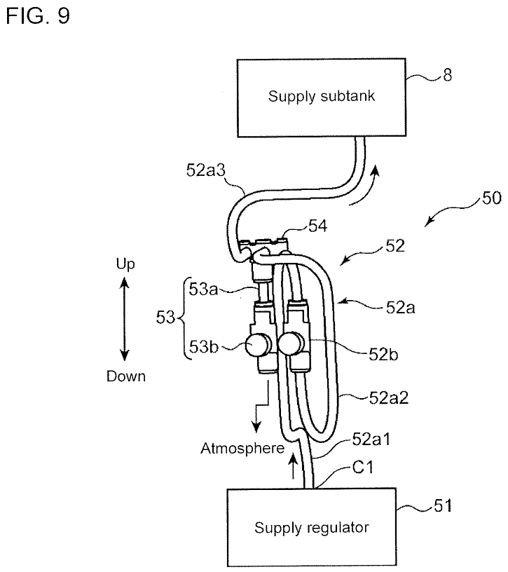

FIG. 9 is a perspective view of the pressurizing tube 52 and the branch tube 53 in the pressurizer 50, illustrating their layouts. As illustrated in the figure, the supply regulator 51 is located below the supply subtank 8 in the present embodiment. The first metering valve 52b in the pressurizing tube 52 and the second metering valve 53b in the branch tube 53 are arranged side by side between the supply regulator 51 and the supply subtank 8. A coupling 54 is located above the second metering valve 53b. The coupling 54 functions as a branch point between the pressurizing tube 52 and the branch tube 53.

The first basal portion 52a in the pressurizing tube 52 extends from the supply regulator 51 to the supply subtank 8 through the first metering valve 52b and the coupling 54. More specifically, the first basal portion 52a includes an upstream tube 52a1 connecting the supply regulator 51 to an upper end (inlet) of the first metering valve 52b, a relay tube 52a2 connecting a lower end (outlet) of the first metering valve 52b to the coupling 54, and a downstream tube 52a3 connecting the coupling 54 to the supply subtank 8. Each of the tubes 52a1, 52a2, and 52a3 extends in the vertical direction while bending or changing the direction as appropriate.

The second basal portion 53a in the branch tube 53 extends downward from the coupling 54. The second basal portion 53a has a lower end connected to an upper end (inlet) of the second metering valve 53b. The second metering valve 53b has a lower end (outlet) open to the atmosphere above the supply regulator 51. In other words, the terminal end of the branch tube 53, or the opening to the atmosphere, is at a higher level than a connection C1 between the pressurizing tube 52 and the supply regulator 51.

### Operational Effects

In the present embodiment, as described above, the pressurizer 50 provides a positive pressure to the supply subtank 8 through air (gas) to cause the internal space of the supply subtank 8 to have a positive pressure higher than the atmospheric pressure. The pressurizer 50 includes the supply regulator 51 that lowers the pressure of air from the pressure source 100, the pressurizing tube 52 connecting the supply regulator 51 to the supply subtank 8, and the branch tube 53 branching from a point on the pressurizing tube 52 and being open to the atmosphere at its terminal end. This structure increases the accuracy of pressure regulation in the supply subtank 8.

More specifically, the pressurizing tube 52 is located between the supply regulator 51 and the supply subtank 8, and the branch tube 53 branching from a point on the pressurizing tube 52 includes its terminal end being open to the atmosphere in the present embodiment. This structure causes the pressure to be provided to the supply subtank 8 through the outlet of the pressurizing tube 52 to decrease in a predetermined proportion to the outlet pressure of the supply regulator 51. In this case, the pressure decrease rate is determined based on the fluidic resistances of the pressurizing tube 52 and the branch tube 53. The fluidic resistances can be regulated to provide an intended positive pressure to the supply subtank 8. In the present embodiment, the pressurizing tube 52 and the branch tube 53 are used to decrease a pressure as described above. This allows the supply pressure change ratio ΔPa, or the ratio of the change in the pressure (supply subtank pressure PAin) in the supply subtank 8 to the change in the outlet pressure (supply regulator pressure PAout) in the supply regulator, to be a value smaller than 1 by a significant difference. The pressure in the supply subtank 8 can thus be regulated in smaller increments than the pressure regulated by the supply regulator 51. This can accurately regulate the pressure in the supply subtank 8 to about the target value.

The terminal end of the branch tube 53 is open to the atmosphere, thus reducing pressure fluctuations in the supply subtank 8. For example, when a large amount of ink is temporarily refilled to the supply subtank 8 or the supply subtank 8 receives an impact, the pressure in the supply subtank 8 may change suddenly. In this case as well, the structure in the present embodiment with the terminal end of the branch tube 53 being open to the atmosphere allows the pressure to be quickly relieved from the terminal end of the branch tube 53, thus reducing the pressure fluctuations described above in a highly responsive manner.

In the present embodiment, the depressurizer 60 provides a negative pressure to the collection subtank 9 through air (gas) to cause the internal space of the collection subtank 9 to have a negative pressure lower than the atmospheric pressure. The depressurizer 60 includes the collection regulator 61 that lowers the pressure of air from the pressure source 100, the vacuum ejector 63 that generates a negative pressure using a flow of air flowing from the collection regulator 61, and the connection tube 64 connecting the negative pressure port 63c in the vacuum ejector 63 to the collection subtank 9. This structure increases the accuracy of pressure regulation in the collection subtank 9.

More specifically, in the vacuum ejector 63 that converts an increase in the flow velocity to a decrease in the pressure, the absolute value of the pressure at the negative pressure port 63c in the vacuum ejector 63 is sufficiently smaller than the inlet pressure of the vacuum ejector 63. In other words, the collection subtank 9 has a negative pressure with its absolute value being sufficiently smaller than the outlet pressure of the collection regulator 61. This indicates that the absolute value of the collection pressure change ratio ΔPb, or the ratio of the change in the pressure (collection subtank pressure PBin) in the collection subtank 9 to the change in the outlet pressure (collection regulator pressure PBout) of the collection regulator 61, is sufficiently smaller than 1. The pressure in the collection subtank 9 can thus be regulated in smaller increments than the pressure regulated by the collection regulator 61. This can accurately regulate the pressure in the collection subtank 9 to about the target value.

In the present embodiment, as described above, the pressurizer 50 provides a positive pressure to the supply subtank 8, and the depressurizer 60 provides a negative pressure to the collection subtank 9. This structure easily increases the pressure difference between the supply subtank 8 and the collection subtank 9, thus raising the upper limit of the amount of ink circulating between the two tanks 8 and 9. This can raise the upper limit of the amount of ink to be ejected from the corresponding ink head 4 per unit time, thus improving the printing performance.

In the present embodiment, the pressurizing tube 52 includes the first metering valve 52b, and the branch tube 53 includes the second metering valve 53b. In this structure, the first metering valve 52b can function as a resistive component that substantially controls the fluidic resistance in the pressurizing tube 52, and the second metering valve 53b can function as a resistive component that substantially controls the fluidic resistance in the branch tube 53. The fluidic resistances of the pressurizing tube 52 and the branch tube 53 can thus be easily changed based on the opening degrees of the respective first metering valve 52b and the second metering valve 53b, thus regulating the supply pressure change ratio ΔPa described above. This structure allows the pressure in the supply subtank 8 to be regulated in small increments as intended, thus achieving highly accurate regulation of the pressure in the supply subtank 8.

More specifically, in the present embodiment, the resistance ratio, which is a value of the second resistance R2 divided by the total (R1+R2) of the first resistance R1 and the second resistance R2, is set to a value in the range of 1/50 to 1/5, where the fluidic resistance of the first metering valve 52b is the first resistance R1 and the fluidic resistance of the second metering valve 53b is the second resistance R2. This structure can lower the pressure in the supply subtank 8 (supply subtank pressure PAin) to 1/50 to 1/5 of the outlet pressure of the supply regulator 51 (supply regulator pressure PAout), thus increasing the accuracy of pressure regulation in the supply subtank 8.

In the present embodiment, the branch tube 53 branches downward from the pressurizing tube 52. This structure allows any ink flowing backward from the supply subtank 8 to the pressurizing tube 52 (downstream tube 52a3) due to, for example, malfunction, to easily flow from the pressurizing tube 52 to the branch tube 53. This reduces the likelihood of the ink flowing backward to the pressurizing tube 52 (the relay tube 52a2 and the upstream tube 52a1) located downstream from the branch point (coupling 54) of the two tubes. The supply regulator 51 is thus less likely to be affected by the ink flowing backward.

In the present embodiment, the terminal end of the branch tube 53, or the opening to the atmosphere, is at a higher level than the connection C1 between the pressurizing tube 52 and the supply regulator 51 (FIG. 9). In this structure, the ink flowing backward into the pressurizing tube 52 (downstream tube 52a3) as described above can be discharged through the terminal end of the branch tube 53 open to the atmosphere before the ink flowing backward flows toward the supply regulator 51. The supply regulator 51 is thus less likely to be affected by the ink flowing backward.

In the present embodiment, the outlet pressure of the supply regulator 51 is regulated based on the pressure of the supply subtank 8 detected by the first pressure sensor SN1, and the outlet pressure of the collection regulator 61 is regulated based on the pressure of the collection subtank 9 detected by the second pressure sensor SN2. This structure can regulate the pressures in the two tanks 8 and 9 to about the target values based on the pressures actually detected in the supply subtank 8 and the collection subtank 9.

### Variations

Although the embodiments of the present disclosure have been described, the present disclosure is not limited to the embodiments described above, and may be varied in various manners without departing from the spirit and scope of the present disclosure. For example, the present disclosure may be implemented as described below.

In the above embodiments, the pressure source 100 that is an air compressor external to the inkjet printer 1 is used as a source of compressed air to be used for the pressurizer 50 and the depressurizer 60. However, any source of compressed air may be used. For example, the inkjet printer 1 may incorporate a pneumatic pump as a source of compressed air to pump air.

In the above embodiments, the pressurizer 50 provides a positive pressure to the supply subtank 8 through air, and the depressurizer 60 provides a negative pressure to the collection subtank 9 through air. However, the medium for transmitting a pressure to the two tanks 8 and 9 may be any gas other than air. For example, the pressure may be provided to the two tanks 8 and 9 through a gas such as a nitrogen gas.

In the above embodiments, the pressurizing tube 52 and the branch tube 53 in the pressurizer 50 include the respective metering valves 52b and 53b (speed controllers). However, the metering valves 52b and 53b may be replaced by orifices. The metering valves 52b and 53b may also be replaced by proportional valves with their opening degrees electrically controllable. More specifically, any components functioning as main resistive components, or the resistors, having higher fluidic resistances than the components (basal portions 52a and 53a) other than the resistors can be used in the pressurizing tube 52 and the branch tube 53. Any type of resistors may thus be used as appropriate.

The ink heads 4 are not limited to those arranged in two arrays on the carriage 3. The ink heads 4 may be in a single array or in three or more arrays. The inkjet printer 1 is not limited to a printer configured to eject multiple colors of ink onto the workpiece W, and may be configured to eject a single color of ink.

The inkjet printer 1 may eliminate the pretreatment liquid head 5 that ejects the pretreatment liquid, the post-treatment liquid head 6 that ejects the post-treatment liquid, and any components associated with these heads.

1. A liquid supply device, comprising:
a supply tank configured to store a liquid to be supplied to a liquid ejection head; and
a pressurizer configured to provide a positive pressure to the supply tank through a gas to cause an internal space of the supply tank to have a positive pressure higher than an atmospheric pressure,
wherein the pressurizer includes
a supply regulator configured to restrict a flow of a gas from a predetermined pressure source to lower a pressure of the gas,
a pressurizing tube connecting the supply regulator to the supply tank to allow the gas with the pressure lowered by the supply regulator to flow to the supply tank, and
a branch tube branching from a point on the pressurizing tube and including a terminal end being open to atmosphere.

2. The liquid supply device according to claim 1, further comprising:
a collection tank configured to store a liquid collected from the liquid ejection head; and
a depressurizer configured to provide a negative pressure to the collection tank through a gas to cause an internal space of the collection tank to have a negative pressure lower than the atmospheric pressure,
wherein the depressurizer includes
a collection regulator configured to restrict a flow of a gas from the pressure source to lower a pressure of the gas,
a vacuum ejector configured to receive the gas with the pressure lowered by the collection regulator, and generate a negative pressure using a flow of the received gas, and
a connection tube connecting a negative pressure port in the vacuum ejector to the collection tank.

3. The liquid supply device according to claim 2, wherein
the pressurizing tube and the branch tube each have a fluidic resistance being set to lower a pressure in the supply tank in a predetermined proportion to an outlet pressure of the supply regulator.

4. The liquid supply device according to claim 3, wherein
the pressurizing tube includes a first basal portion being tubular, and a first resistor having a higher fluidic resistance than the first basal portion, and
the branch tube includes a second basal portion being tubular and branching from the first basal portion at a position downstream from the first resistor, and a second resistor having a higher fluidic resistance than the second basal portion.

5. The liquid supply device according to claim 4, wherein
a resistance ratio being a value of a fluidic resistance of the second resistor divided by a total of fluidic resistances of the first resistor and the second resistor is set to 1/50 to 1/5 inclusive.

6. The liquid supply device according to claim 5, wherein
the liquid supply device satisfies formula 1 below, where ΔPa is a supply pressure change ratio being a ratio of a change in the pressure in the supply tank to a change in the outlet pressure of the supply regulator, and ΔPb is a collection pressure change ratio being a ratio of a change in a pressure in the collection tank to a change in an outlet pressure of the collection regulator.
−0.1×ΔPb<ΔPa<−10×ΔPb (1)

7. The liquid supply device according to claim 2, further comprising:
a first pressure sensor configured to detect a pressure in the supply tank;
a second pressure sensor configured to detect a pressure in the collection tank; and
a controller configured to regulate an outlet pressure of the supply regulator based on a detection value from the first pressure sensor, and regulate an outlet pressure of the collection regulator based on a detection value from the second pressure sensor.

8. The liquid supply device according to claim 1, wherein
the branch tube branches downward from the pressurizing tube.

9. The liquid supply device according to claim 8, wherein
the terminal end of the branch tube is at a higher level than a connection between the pressurizing tube and the supply regulator.

10. A recording apparatus, comprising:
the liquid supply device according to claim 1, the liquid supply device being configured to supply ink being the liquid; and
the liquid ejection head configured to eject the ink supplied from the liquid supply device onto a predetermined recording medium.

11. The recording apparatus according to claim 10, further comprising:
a pneumatic pump being the pressure source, the pneumatic pump being configured to pump a gas.
